(19) United States
(12) Patent Application Publication
(10) Pub. No.: US 2015/0371575 A1
(43) Pub. Date: Dec. 24, 2015

(54) LED display for wind turbines

(71) Applicant: Anne-Julie Rosemarie Carl, (US)

(72) Inventor: Anne-Julie Rosemarie Carl, Huckeswagen (DE)

(21) Appl. No.: 14/307,552

(22) Filed: Jun. 18, 2014

(51) Int. Cl. G09G 3/00; F03D 3/00; G09G 3/12

(52) U.S. Cl. CPC G09G 3/005; G09G 3/12; F03D 3/005

(57) ABSTRACT

The invention comprises of the installation of an array of light emitting diodes (LEDs) to the moving parts of any wind turbine. The LEDs are controlled to generate a viewable image when the turbine blades or other parts are rotating. The image is generated by individual control of each LED while the array of LEDs follows the movement of the wind turbine blades, thus sweeping an area where the image appears. Means for controlling the LEDs include variable speed control to generate steady or moving images when the turbine rotates at variable rotational speeds. Electricity generated by the turbine may be used to power the LEDs and controller. LED arrays can be arranged anywhere on the moving parts of the turbine.

A wind turbine comprises of a shaft about a longitudinal axis and a plurality of blades coupled to the shaft. At least one of the blades has an array of light emitting diodes controlled to generate a viewable image when the turbine rotates about the axis. The image is generated by individual control of each LED while the array of LEDs follows the movement of the wind turbine blades, thus sweeping an area where the image appears. Means for controlling the LEDs include variable speed control to generate steady or moving images when the turbine rotates at variable rotational speeds. Electricity generated by the turbine may be used to power the LEDs and controller. LED arrays can be arranged anywhere on the moving parts of the turbine.

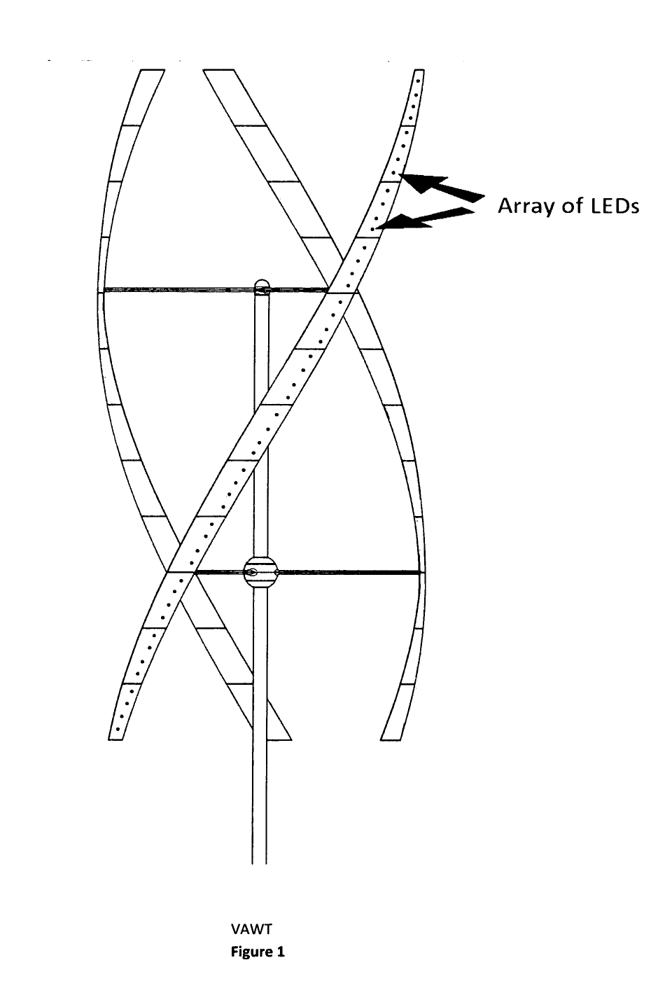

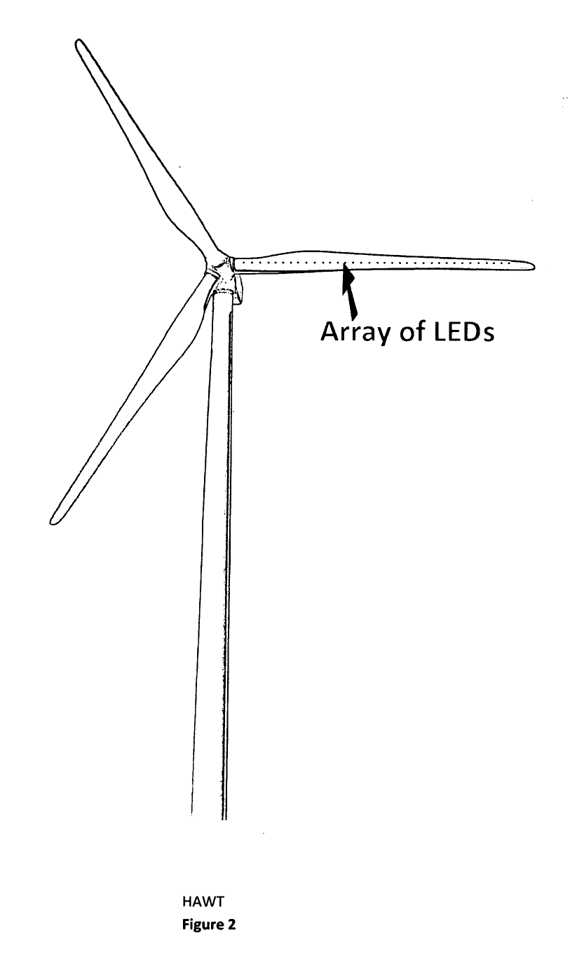

The invention relates in particular, but not exclusively, to vertical axis wind turbines (VAWTs). An example of a VAWT is shown in FIG. 1. Applications of this invention in conjunction with VAWTs provide images in form of a cylinder, a cone or any other rotational body, depending on the blade shape. Applications of this invention in conjunction with horizontal axis wind turbines (HAWTs) as shown in FIG. 2 provide a flat image. An image in conjunction with a HAWT can be viewed from one side of the turbine, if an array of LEDs is installed to one side of one or more blades of the turbine.

With both a VAWT and an HAWT two separate images can be viewed, if two arrays of LEDs are installed to both sides of one or more blades of the wind turbine.

The invention relates in particular, but not exclusively, to wind turbines used in urban environments as the ability to display viewable text, images and video provides a number of applications such as, but not limited to, advertisements, signs, illumination, art, decoration, etc.

1. A wind turbine comprising a shaft rotatable about a longitudinal axis and a plurality of substantially rigid blades mechanically coupled to the shaft, at least one of the blades or other part mechanically coupled to the shaft comprising an array of light emitting diodes controllable under action of a control means to generate a viewable image when the turbine rotates about the longitudinal axis.

2. A wind turbine as claimed in claim 1 wherein the control means comprises variable speed control means to generate a coherent viewable image when the turbine rotates at variable rotational speeds.

3. A wind turbine as claimed in claim 1 wherein the control means comprises variable speed control means to generate a viewable image at a constant moving speed when the turbine rotates at variable rotational speeds.

4. A wind turbine as claimed in claim 1 wherein the control means comprises variable speed control means to generate a viewable video when the turbine rotates at variable rotational speeds.

5. A wind turbine as claimed in claims 1 through 4 wherein the turbine generates electricity to power the light emitting diodes.
